(19) United States
(12) Patent Application Publication
(10) Pub. No.: US 2008/0275769 A1
(43) Pub. Date: Nov. 6, 2008

(54) NETWORK-BASED INTERACTIVE ENTERTAINMENT CENTER

(76) Inventor: Billy Jye-en Shao, Union City, CA (US)

Correspondence Address: XIN WEN, 3449 RAMBOW DRIVE, PALO ALTO, CA, 94306, US

(21) Appl. No.: 11/744,800

(22) Filed: May 4, 2007

(51) Int. Cl. G06F 19/00

(52) U.S. Cl. 705/14

(57) ABSTRACT

A network system for providing an entertainment center in a virtual community includes a computer storage configured to store information about a user, a server configured to support a web user interface on a remote computer device. The web user interface includes an entertainment center including a screen configured to display an image, and one or more seats to be seated by one or more avatars while they watch the image on the screen and a mechanism adapted to control the display of the image on the screen. At least one of the one or more avatars is associated with the user.

### TECHNICAL FIELD

This application relates to an interactive entertainment center in an Internet-enabled virtual world.

### BACKGROUND

Interactive online digital entertainment has advanced on many fronts in recent years, especially with respect to video gaming. For example, users can login to websites to find an opponent and then a game of chess or a card game in the virtual world. As a player may be competing against another player, the communication is bi-directional. However, not all video games can be played online. For a game of chess where time to make a move does not have an immediate and consequential effect on the outcome, players have time to contemplate the next move, counter move, game strategy and so on and the games does not need to provide real-time feedback. However, in a majority of real-time video games, time needed to make a decision and act upon that decision is relatively short so that players involved feel a sense of realism and engagement. In such a real-time game, action must occur in close proximity to real life events. Real-time action is required for the action games, simulation games such as flight simulators and sport games. In most cases persistent communications, scoring, player attributes, etc. cannot be offered together with real-time realism and engagement. Scalability is another challenge to the network-based game application. While some existing network-based systems can handle tens of thousands of game players, it is a serious challenge to provide game applications in real time to millions of players reliably and simultaneously.

Another challenge for online digital entertainment is provide the right kinds of interactivity and real-world features to provide enjoyable experiences to users and can therefore be attractive to a large number and wide range of users.

In one aspect, the present invention relates to a network system for providing an entertainment center in a virtual community. The network system includes a computer storage configured to store information about a user and a server configured to support a web user interface on a remote computer device. The web user interface includes an entertainment center including a screen configured to display an image; and one or more seats to be seated by one or more avatars while they watch the image on the screen, wherein at least one of the one or more avatars is associated with the user; and a mechanism adapted to control the display of the image on the screen.

In another aspect, the present invention relates to a web user interface for an entertainment center in a network-based virtual community. The web user interface includes an entertainment center including: a screen configured to display an image; and one or more seats to be seated by one or more avatars while they watch the image on the screen. The also web user interface includes a mechanism adapted to control the display of the image on the screen under the control by a user, wherein at least one of the one or more avatars is associated with a user.

In yet another aspect, the present invention relates to a method for a method for providing an entertainment center in a virtual community. The method includes providing a web user interface by a web server on a remote computer device operated by a user; streaming video data by a streaming server to the remote computer device; displaying on the web user interface an entertainment center having a screen configured to display images in response to the video data and one or more seats configured to be seated by one or more avatars while they watch the images on the screen; displaying one or more avatars in the entertainment center on the web user interface, wherein at least one of the one or more avatars is associated with the user; and displaying a mechanism adapted to control the display of the images on the screen.

Implementations of the system may include one or more of the following. The screen can display a movie, a video clip, trivia questions, or a slideshow. The network system can further include streaming server configured to provide streamed video data to the remote computer device to enable the screen to display one or more of the movie, the video clip, and the slideshow. The image displayed on the screen can include advertisement information. The advertisement information can be produced using information about the user stored on the computer storage. The web user interface can further include a refreshment stand configured to sell or provide refreshments to the one or more avatars. The web user interface can further include a facility configured to sell or provide music or songs to the one or more avatars or a user associated with one of the one or more avatars. The web user interface can further include a facility configured to sell a ticket to an avatar to allow the avatar to enter the entertainment center. The ticket can be sold in a real-world currency. The ticket can be sold in a virtual world currency. The web user interface can further include a mechanism to display comments about the image displayed on the screen from the one or more avatars.

Embodiments may include one or more of the following advantages. The disclosed system and methods can provide users satisfying experiences in an interactive entertainment center in an online virtual world. Users' persona or their avatars can attend a movie theater that mimics a real-world movie cinema with movie screen, seats for audience, refreshment, and so on. The disclosed system and methods also provide an effective marketing channel to communicate to users of the online interactive entertainment center. The communications can include trivia and advertisement slideshows, previews similar to real-world movie theaters. The communications can also be personalized and segmentized using digital data collected about the users. The disclosed system and methods can also allow users to interactive with each other and play games in real time in the online interactive entertainment center. Furthermore, the disclosed system and methods allow users to flexibly pay for their entertainment with real-world currency, virtual-world currency, and credits in the users' account.

Details of one or more embodiments are set forth in the accompanying drawing and in the description below. Other features, objects, and advantages of the invention will become apparent from the description and drawings, and from the claims.

### BRIEF DESCRIPTION OF THE DRAWINGS

FIG. 1 is a system diagram of a network-based game system.

FIG. 2A illustrates an exemplified online entertainment center.

FIG. 2B illustrates an exemplified online entertainment center showing an advertisement slideshow.

FIG. 2C illustrates an exemplified online entertainment center showing a movie.

FIG. 3 is a flow diagram for the operations of an exemplified online interactive entertainment center.

### DETAILED DESCRIPTION

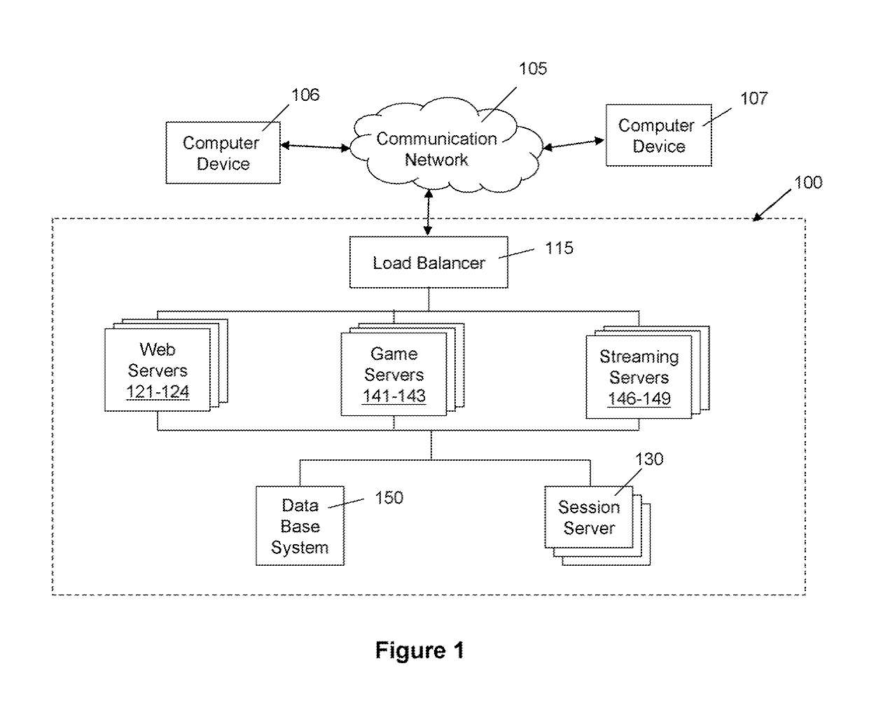

Referring to FIG. 1, a network-based game system 100 can include a load balancer 115, one or more web servers 121-124, one or more session servers 130, a plurality of game servers 141-143, and a data base system 150. The data base system 150 can for example be implemented as a storage area network. The load balancer 115 can include one or a system of servers that are designed to ensure redundancy and reliability for the network-based game system 100. The network-based game system 100 can also include one or more streaming servers 146-149 for providing streamed video content to be played in interactive entertainment centers on the web user interface on remote computer devices 106 and 107, as described below. In some embodiments, the streaming operations can be performed by the web servers 121-124 or the game servers 141-143. The network-based game system 100 can be operated by a game service provider. The network-based game system 100 can allow users of computer devices 106 and 107 to access an interactive online entertainment center through a web browser such as Internet Explorer™ from Microsoft, Netscape™ from AOL, and Firebox™ from Mozilla and so on. The network-based game system 100 can also provide a website on the Internet to host a game community and provide various game services such as games, discussion groups, forums, and e-mails etc. Users can participate in the online interactive games using game applications running on computer devices 106 and 107 through a communication network 105.

The communication network 105 can include various wired, wireless, satellite communication arrangements including but not limited to a wide area network such as the Internet, a local area network, a cellular phone network under various communication protocols such as 2G, 2.5G and 3G, Global System for Mobile Communications (GSM), General Packet Radio Service (GPRS), EDGE, Code Division Multiple Access (CDMA), Wideband CDMA, TD-SCDMA, Universal Mobile Telecommunications System (UMTS), etc., city wide wires network such as WiMax, and wireless local area network (WLAN) such as Wi-Fi wireless communication standards such as IEEE 802.11, Wi-Max, and IEEE 806.16, and others. The computer devices 106 and 107 can include personal computers, portable digital assistance (PDA) devices, cell phones, digital image capture devices, and dedicated game devices such as Microsoft XBOX, SONY PlayStation OR PS2, Nintendo gaming machines, GameCube, or GameBoy.

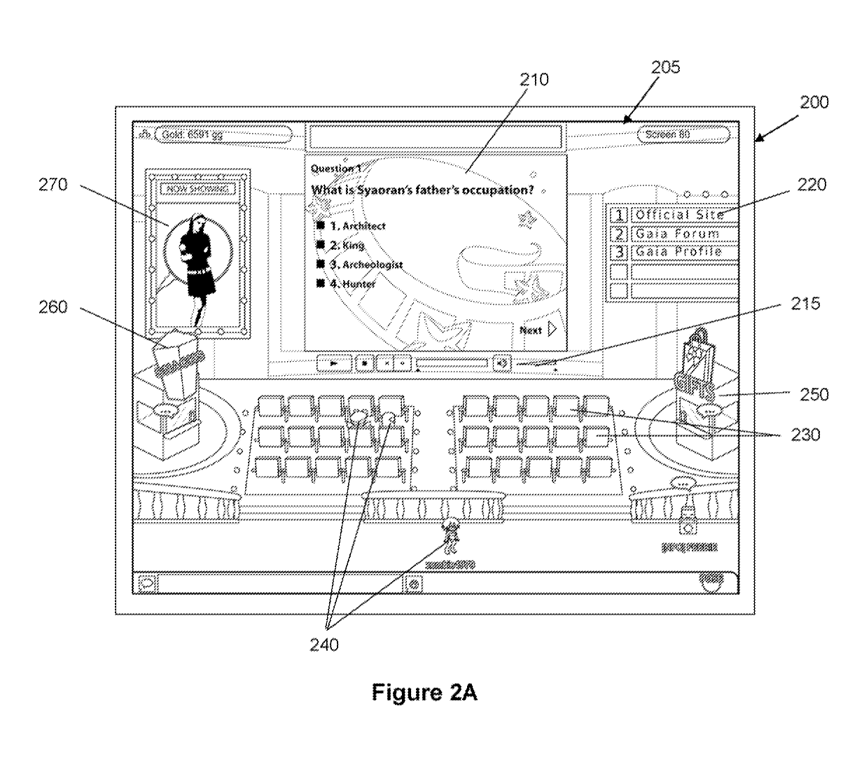

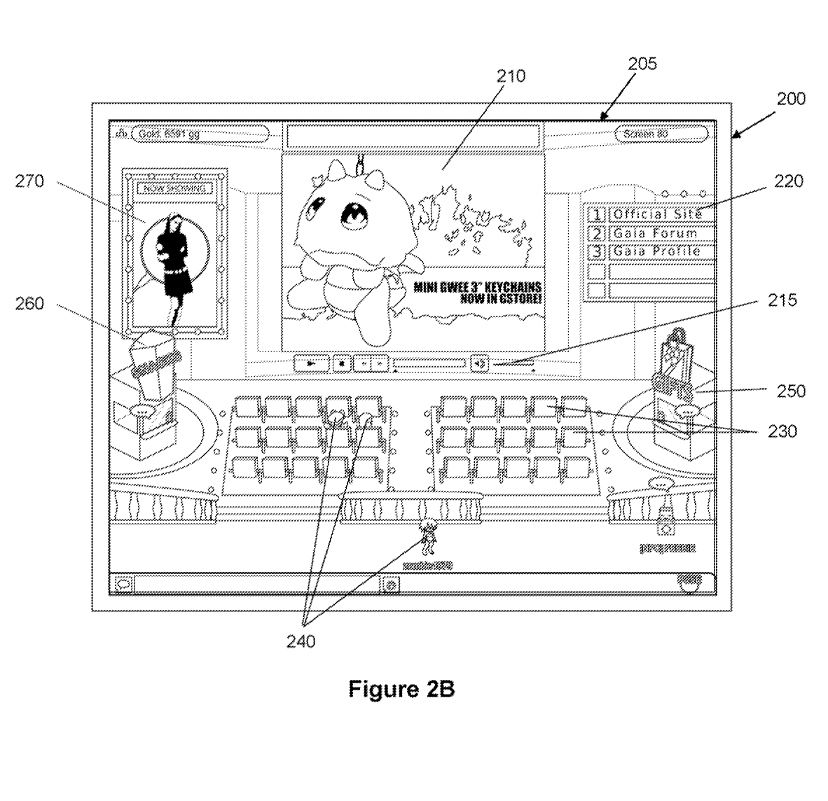

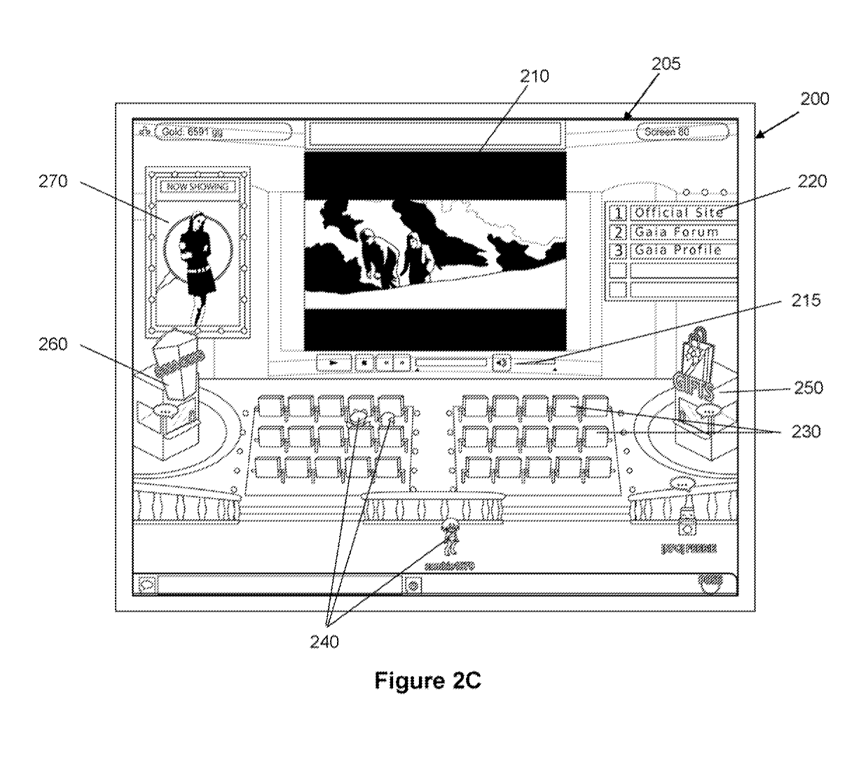

Referring to FIGS. 2A-2C, an exemplified online entertainment center 205 can be presented by a web user interface 200 such as a web browser. The online entertainment center 205 can include a plurality of cinema halls. A cinema hall can include a screen 210 for displaying movies, videos, and other dynamic or static image information, and display control 215 for a user to control the display of the image content on the screen 210. The video image stream can be provided by the streaming servers 146-149 in the network-based game system 100. The online entertainment center 205 can include one or more cinema halls. One or more movies and video clips can be displayed in the one or more cinema halls. A display 270 can show the movie to be played or currently being played in the hall shown in the web user interface 200. The display 270 can also carry advertisement from a real-world movie cinema such as Century Cinema and AMC, advertisement about a movie on DVD, the newest model on a portable MPEG music player or a cool cell phone. A display 220 can also list other movies available for showing, and movies currently being shown in other cinema halls in the same online entertainment center 205.

The online entertainment center 205 can also include one or more seats 230 for avatars 240 to sit on while watching image display on the screen 210. Each of the avatars 240 in the online entertainment center 205 is associated with a user that has chosen to enter the online entertainment center 205. An avatar 240 can be a user's persona having the appearance (including for example gender, age, height and weight, ethnic background, spoken language and accent) pre-selected by the user. The avatar 240 can also wear clothing, jewelry, and carry portable devices such as a mobile phone, an MPEG player, etc. that the user has purchased for the avatar.

The online entertainment center 205 can also include other facilities and services that can include real-world or virtual world products and services, and can be purchased by real-world or virtual world currencies. The online entertainment center 205 can include a kiosk 250 that enables the avatars (or the associated users) to purchase real life merchandise related to the video (DVDs, posters, movie tickets, etc), merchandise in the virtual world, and music tracks that can be used in the theater and in the video, and a refreshment stand 260 that can sell pop corns, drinks, candies, etc. similar to a snack bar in a real-world movie theater. The refreshment stand 260 can also include a gift stand that can display various gifts, and toys, for sale. For example, a user can purchase a beach ball, food fight, and movie related emotes for his or her avatar. Moreover, the users can purchase streamed music from a list of songs. Each song including the information about the music can be streamed in different formats such as CD, MPEG3, iTunes, etc. The online entertainment center 205 can also include a lounge to promote and sell the paintings of certain artists. The online entertainment center 205 can also host a concert to promote a musician or one or more dancers.

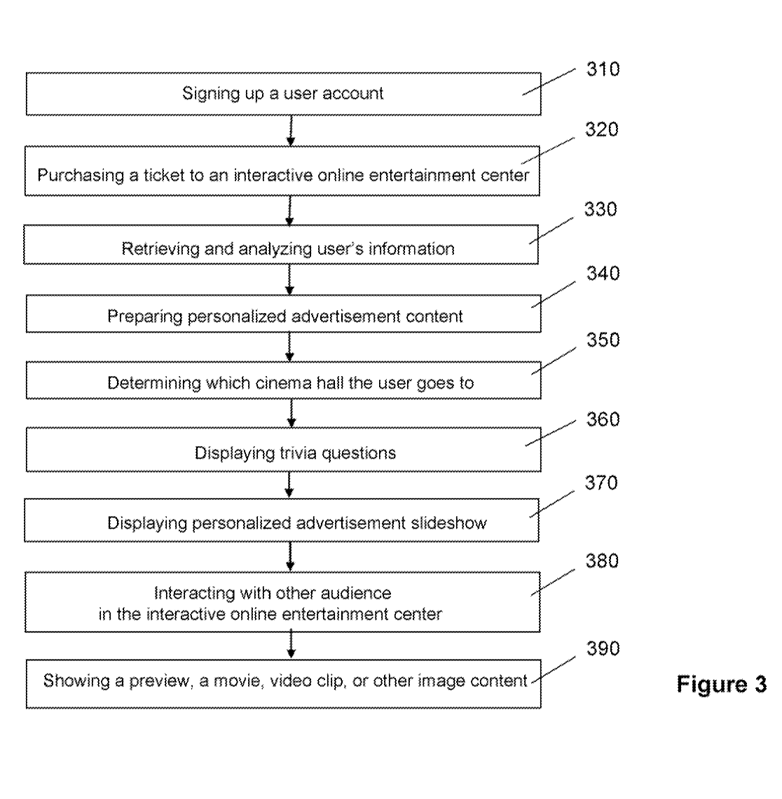

Referring to FIG. 3, a user can sign up at a website to own an account at the online service provider that provides the interactive online entertainment center 205 (step 310). The user can also store the user's hobbies, favorite activities, consumer interests, geographic location in the user's profile. The user can also set up a list of buddies. The user may play with some of the buddies in multi-player network-based games. The network-based system 100 can store favorite activities and products, statistics, geographic locations of the users in a networked storage device, which can be regularly updated. Information about the user can be stored in the database system 150.

A user or a game player can access the web site of the game service provider using computer devices 106 and 107 with a web browser application executed on the computer devices 106 or 107. Various Internet browsing applications are available to cellular phones, PDAs, game consoles, which are also compatible with the disclosed system and methods.

Once the avatar of a user joins a virtual-world community, the avatar can decide to go to an interactive online entertainment center 205 (such as a movie theater). The avatar can go a box office shown in the user interface, select a movie, and purchase a ticket. The avatar or the user the avatar represents can purchase a ticket to the interactive online entertainment center 205 using real-world currencies, a virtual world currency, or other forms of credits in the user's accounts (step 320). For example, the virtual-world currency and credits can be earned by the avatar's activities in the virtual-world community. A user can for example earn virtual-world currency by winning online games, creating or designing properties or asset in the virtual world, or making contributions to the virtual-world community. The user can also purchase a movie pass that allows the avatar of the user to enter interactive online entertainment center 205 for a period of time such as a month or a year.

Once the user purchases a ticket to the interactive online entertainment center 205, information about the user can be retrieved from the database system 150, and analyzed by for example a web server 121-124 (step 330). The web server can examine the user's use history at the web site, the user's consumption interest, age, gender, and geographic locations. The web server can also analyze the geographic region where the user has logged from. An application running on the network-based game system 100 can subsequently prepare personalized advertisement content (step 340) in accordance to the retrieved use information and the results of the analysis. For example, if it is known that the user owns a car in a particular region, services such as car maintenance near the user can be shown later on the screen. In another example, if it is known that the user frequently goes skiing, discount to a ski field may be played later in the advertisement slideshow. The advertisement content can be tailored to the user or a segment of users having the common interest. In yet another example, if it known that the user is a cyclist, information a future riding event or a bicycle race may be presented to during the advertisement slideshow. Other advertisement information can include restaurant, coffee shops, sales at certain stores or online, etc. The advertisement slideshow can also promote services and facilities in the virtual world or announcement from fellow members of virtual world. Similarly, personalized trivia questions can also be prepared for display to the user (and the avatar of the user) before the movie show. The service provider can be paid by the related businesses for presenting to the advertisement slideshows to the users and their avatars.

The interactive online entertainment center 205 can include many or almost unlimited number of cinema halls that can simultaneously show many more movies than a real-world movie theater. The network-based game system 100 can thus choose which cinema hall to assign the user to (step 350). For example, the user can be assigned to a cinema hall with other users that share similar interests such as they can enjoy the same trivia questions and advertisement slideshow together. In another example, if users that are on each other's buddies' list both purchase tickets to watch the same movie, they may be assigned to the same cinema hall. In yet another example, users that want to watch the same movie at substantially the same time can be assigned to the same cinema hall.

The user's avatar 240 can enter a cinema hall as assigned by the network-based game system 100 or by her choice. The avatar can buy refreshment drinks, pop corns from the refreshment stand 260. The avatar 240 can also order or purchase music and songs at the kiosk 250 before the show. The avatars 240 can find seats to sit down just like in a real-world movie theater. Trivia questions can be shown on the screen 210 (FIG. 2A, step 360). The trivia questions can be personalized specific to the user, as described above. Advertisement slideshows can also be played (FIG. 2B, step 370). For example, as shown in FIG. 2B, a slide on the screen 210 can show the avatar audience about a character key chain on sale in a virtual store.

The avatars 240 and their associated users can actively participate in the entertainment activities and interact with each other during the showings of the trivia questions and advertisement slideshows (step 380). For example, the avatars 240 can throw pop corns on a stage or at the screen 210. The users can also write comments about the trivia questions and advertisement slideshows, and publish or broadcast the comments to all the users with their avatars in the same cinema hall. The avatars 240 can also throw beach balls over the audience and participate in food fights, etc.

The avatars 240 and their associated users can also participate in a market survey or a poll. For example, a window can be shown on a sidebar or as a pop-up to ask the user questions. The user can select an answer in multiple choices or enter his or her answer in text. A movie preview, a movie, video clips, or other image content can next be shown on the screen 210 (step 390, FIG. 3C). The movies can user may use the control 215 to control volume, brightness, and color balance. In some embodiments, the movies can be shown to different users at different speeds. A user can use the control 215 to play, stop, Pause, rewind, synchronize movie with other avatars, and seek a specific scene. A suer can also control playing speed, fast forward, backward etc. during the play of the movie.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. For example, the disclosed system is compatible with different computer devices that can access the website, and different layouts and different forms of web user interfaces on computer devices.

The interactive online entertainment center is compatible with private screening events by an invited group of users and their avatars that rent a cinema hall in the interactive online entertainment center. The interactive online entertainment center is compatible with a private entertainment party at a private facility in the virtual online community. The interactive online entertainment center can also be developed in module fashion to be made available at a plurality of websites operated by different entities. The websites can provide interactive online entertainment centers to users of various types of computers (desktop, laptop, tablet, etc.), portable devices (PDA, cell phones, IPEG music players, and portable gaming machines, etc.), and stationary gaming kiosks.

What is claimed is:

1. A network system for providing an entertainment center in a virtual community, comprising:
a computer storage configured to store information about a user; and
a server configured to support a web user interface on a remote computer device, wherein the web user interface includes:
an entertainment center including a screen configured to display an image;
and one or more seats to be seated by one or more avatars while they watch the image on the screen, wherein at least one of the one or more avatars is associated with the user; and
a mechanism adapted to control the display of the image on the screen.

2. The network system of claim 1, wherein the screen is configured to display a movie, a video clip, trivia questions, or a slideshow.

3. The network system of claim 2, further comprising streaming server configured to provide streamed video data to the remote computer device to enable the screen to display one or more of the movie, the video clip, and the slideshow.

4. The network system of claim 1, wherein the image displayed on the screen includes advertisement information.

5. The network system of claim 4, wherein the advertisement information is produced using information about the user stored on the computer storage.

6. The network system of claim 1, wherein the web user interface further comprises a refreshment stand configured to sell or provide refreshments to the one or more avatars.

7. The network system of claim 1, wherein the web user interface further comprises a facility configured to sell or provide music or songs to the one or more avatars or a user associated with one of the one or more avatars.

8. The network system of claim 1, wherein the web user interface further comprises a facility configured to sell a ticket to an avatar to allow the avatar to enter the entertainment center.

9. The network system of claim 8, wherein the ticket is sold in a real-world currency or a virtual world currency.

10. The network system of claim 1, wherein the web user interface further comprises a mechanism to display comments about the image displayed on the screen from the one or more avatars.

11. A web user interface for an entertainment center in a network-based virtual community, comprising:
an entertainment center including:
a screen configured to display an image; and
one or more seats configured to be seated by one or more avatars while they watch the image on the screen; and
a mechanism adapted to control the display of the image on the screen under the control by a user, wherein at least one of the one or more avatars is associated with the user.

12. The web user interface of claim 11, wherein the screen is configured to display a movie, a video clip, trivia questions, or a slideshow.

13. The web user interface of claim 11, wherein the image displayed on the screen includes advertisement information.

14. The web user interface of claim 11, further comprising one or more of a refreshment stand configured to sell or provide refreshments to the one or more avatars and a facility configured to sell or provide music or songs to the one or more avatars or a user associated with one of the one or more avatars.

15. The web user interface of claim 11, further comprising a facility configured to sell a ticket to an avatar to allow the avatar to enter the entertainment center.

16. The web user interface of claim 15, wherein the ticket is sold at the facility in a real-world currency or a virtual world currency.

17. The web user interface of claim 11, further comprising a mechanism to display comments about the image displayed on the screen from the one or more avatars.

18. A method for providing an entertainment center in a virtual community, comprising:
providing a web user interface by a web server on a remote computer device operated by a user;
streaming video data by a streaming server to the remote computer device;
displaying on the web user interface an entertainment center having a screen configured to display images in response to the video data and one or more seats configured to be seated by one or more avatars while they watch the images on the screen;
displaying one or more avatars in the entertainment center on the web user interface, wherein at least one of the one or more avatars is associated with the user; and
displaying a mechanism adapted to control the display of the images on the screen.

19. The method of claim 18, further comprising:
storing information about the user on a computer storage;
producing advertisement using the information about the user stored on the computer storage; and
displaying the advertisement on the screen in the entertainment center on the web user interface.

20. The method of claim 18, further comprising displaying a movie, a video clip, trivia questions, or a slideshow on the screen in the entertainment center on the web user interface.

21. The method of claim 18, further comprising selling or providing refreshments to the one or more avatars in the entertainment center on the web user interface.

22. The method of claim 18, further comprising providing a facility in the web user interface to sell or provide music or songs to the one or more avatars or the user.

23. The method of claim 18, further comprising selling a ticket to an avatar to allow the avatar to enter the entertainment center.

24. The method of claim 18, further comprising selling the ticket in a real-world currency or a virtual world currency.

25. The method of claim 18, further comprising displaying comments about the image displayed on the screen from the one or more avatars.
